(19) United States
(12) Patent Application Publication
(10) Pub. No.: US 2024/0060846 A1
(43) Pub. Date: Feb. 22, 2024

(54) GAS SENSOR AND METHOD FOR DETECTING GAS

(71) Applicant: WEISS UMWELTTECHNIK GMBH, Reiskirchen (DE)

(72) Inventors: Yannik Zahrt, Rabenau (DE); Felix Diehl, Laubach (DE)

(21) Appl. No.: 18/139,816

(22) Filed: Apr. 26, 2023

(30) Foreign Application Priority Data
Apr. 28, 2022 (DE) 10 2022 110 340.4

(51) Int. Cl. G01M 3/04

(52) U.S. Cl. CPC G01M 3/04

(57) ABSTRACT

The invention relates to a gas sensor (34) and a method for detecting gas in a test space (37) of a test chamber for conditioning air, in particular a temperature control chamber, a climate chamber or the like, and to a test chamber, the gas sensor having a sensor head (35) configured to be brought into contact with an atmosphere of the test space. The gas sensor is configured to detect a gas, in particular a refrigerant and/or a hydrocarbon, in the test space, the gas sensor having a transport tube (36) configured to transport a measuring gas from the test space to the sensor head.

The invention relates to a gas sensor and a method for detecting gas in a test space of a test chamber for conditioning air, in particular a temperature control chamber, a climate chamber or the like, and to a test chamber having a gas sensor, the gas sensor having a sensor head configured to be brought into contact with an atmosphere of the test space.

Gas sensors are sufficiently known and typically serve to detect gases in an atmosphere or air atmosphere. A gas sensor has what is referred to as a sensor head, which can be brought into contact with the atmosphere in question. For example, the gas sensor can comprise a sensor housing within which the sensor head is disposed. In this manner, the sensor head can be protected from mechanical damage, for example. Furthermore, it is known for gas sensors of this kind to be placed in a test space of a test chamber in order to be able to detect gases potentially produced by an object to be tested. However, gas sensors of this kind can only be used within a relatively narrow temperature range and under moderate climatic conditions. Very high relative air humidity or very low or high air temperatures easily cause the gas sensor to fail or even be destroyed.

Test chambers are typically used to test physical and/or chemical properties of objects, in particular devices. For instance, temperature test cabinets or climate test cabinets within which temperatures in a range of −50° C. to +180° C. can be set are known. Climate test cabinets additionally allow desired climatic conditions to be set, to which the device or the test material is then exposed for a defined period of time. The temperature of the test space holding the test material to be tested is typically controlled in a circulating-air duct within the test space. The circulating-air duct forms an air treatment space in the test space, in which heat exchangers for heating or cooling the air flowing through the circulating-air duct or the test space are disposed. A fan or a ventilator aspirates the air present in the test space and leads it to the respective heat exchangers in the circulating-air duct. In this manner, the temperature of the test material can be controlled or the test material can be exposed to a defined change in temperature. For example, a temperature can change between a maximum temperature and a minimum temperature of the test chamber during a test interval. Such a test chamber is known from EP 0 344 397 A2.

The refrigerant used in a cooling circuit of the test chamber should have a relatively low CO2 equivalent; i.e., a relative global warming potential (GWP) should be as low as possible in order to avoid indirect damage to the environment in case the refrigerant is released. As per statutory regulations, a refrigerant must not significantly contribute to the depletion of ozone in the atmosphere or to global warming. This means that essentially no fluorinated or chlorinated substances are to be used as refrigerants, which is why natural refrigerants, such as carbon dioxide (CO2), are an option. Such refrigerants with a low GWP are disadvantageous in that these refrigerants tend to have a significantly lower cold capacity in the temperature ranges relevant for a cooling circuit than refrigerants with a comparatively higher GWP. While it is also known for hydrocarbons to be used as refrigerants, they are disadvantageous in that they are highly flammable. Flammability refers to the refrigerant's property of reacting to ambient oxygen by releasing heat. A refrigerant is flammable in particular if it is classified in fire class C of European standard EN2 and DIN 378 classes A2, A2L and A3 in their latest versions as at the priority date. The use of a flammable refrigerant complicates filling, shipping and operation of a cooling circuit and a test chamber because of the safety regulations that may have to be observed. A possible leakage of the cooling circuit within the test space is a significant problem since electrical resistance heaters and other electrically operated devices may be located in the test space as the test material. Hence, an explosion may occur in the event of a leak.

Hence, the object of the present invention is to propose a gas sensor, a method for detecting gas and a test chamber having a gas sensor which allow safe operation.

This object is attained by a gas sensor having the features of claim 1, a test chamber having the features of claim 16 and a method having the features of claim 19.

The gas sensor according to the invention for detecting gas in a test space of a test chamber for conditioning air, in particular a temperature control chamber, a climate chamber or the like, has a sensor head configured to be brought into contact with an atmosphere of the test space, the gas sensor being configured to detect a gas, in particular a refrigerant and/or a hydrocarbon, in the test space, the gas sensor having a transport tube configured to transport a measuring gas from the test space to the sensor head.

The gas sensor according to the invention serves to detect gas, i.e., a gaseous substance or substance mixture present in the air and capable of forming an explosive atmosphere together with the air in the test space. In this context, gas refers to a defined type of gas not typically present in the air of earth's atmosphere. The gas sensor now allows detecting a defined type of gas in the atmosphere of the test space. The atmosphere of the test space refers to a gas atmosphere or a volume within the test space, the test space being hermetically sealed from an environment. The gas detectable by the gas sensor can be a refrigerant and/or hydrocarbon, for example. Thus, it is now possible to detect refrigerant located in the test space in the event of a leak of the test chamber, for example, and thus detect the formation of an explosive atmosphere in time. In order for the gas sensor to also be usable for the very high and very low temperatures and the different climatic conditions typically established in the test space, the gas sensor has the transport tube, through which the measuring gas originating from the test space or air located in the test space can be transported from the test space to the sensor head. This makes it possible for the sensor head to be disposed in such a manner that it is protected from mechanical damage while not necessarily being exposed directly to the temperatures and the climatic conditions in the test space. By transporting the measuring gas through the transport tube, the temperature of the measuring gas can also be controlled on its way through the transport tube to the sensor head. For example, a comparatively high or low temperature of the measuring gas can be adjusted to an admissible operating temperature of the sensor head. In this context, the term measuring head refers to the actual sensor, i.e., a discrete component serving to immediately detect the gas. Since the sensor is able to detect gases potentially present in the atmosphere of the test space even at temperatures and climatic conditions harmful to the sensor head otherwise, safe operation of a test chamber can be improved significantly with the gas sensor.

The gas sensor can be configured to detect gas in the test space at a temperature in a temperature range of −50° C. to +180° C. within the test space. Also, the gas sensor can be suitable for detecting gas within the test space at a temperature in a temperature range of −70° C. to +180° C., preferably −85° C. to +200° C.

The gas sensor can be configured to detect a change in a composition of the atmosphere of the test space. Advantageously, the gas sensor can detect any type of change in the atmosphere of the test space or the composition of the air present in the test space. Aside from a leak of the test chamber, it is also possible for the gas sensor to be used to detect gases leaking from an object to be tested or gases occurring in the course of a test process. This makes it possible for the gas sensor to also be used to test an object or a product directly.

The gas sensor can be calibrated to detect a refrigerant, preferably a refrigerant having the lowermost lower explosive limit. Thus, it can be ensured that a leak of refrigerant of the test chamber into the test space is safely detected. The gas sensor can be calibrated in such a manner that refrigerants capable of forming an explosive atmosphere together with the air in the test space are detected. To ensure this, the refrigerant having the lowermost lower explosive limit can be detected. In this context, refrigerants refer to fluids according to DIN EN 378-1 in its latest version as at the priority date.

The sensor head can be a reaction heat sensor or a catalytic bead sensor or an infrared sensor. A reaction heat sensor can catalytically combust potentially present flammable gas by catalytic combustion and detect their existence based on the resulting increase in temperature. A reaction heat sensor is particularly cost-efficient; however, it can only be used within a certain temperature range.

The gas sensor can have a pump for transporting the measuring gas from the test space to the sensor head through the transport tube. The pump can be a rotation pump, a piston pump or the like. The pump can suction the measuring gas out of the test space and transport it to the sensor head through the transport tube. This makes it possible for the transport tube to be of basically any length and thus for the sensor head to also be disposed at a comparatively large distance from the test space. In principle, however it is also possible for the sensor head to be disposed within the test space together with the gas sensor if the sensor head is insulated from the temperatures in the test space. The pump can also ensure a continuous transport of measuring gas and thus a continuous measurement. Furthermore, it would also be possible for the gas sensor to be configured without a pump. In this case, a flow of measuring gas through the transport tube would have to be made possible in another manner.

The pump and/or the transport tube can be provided with a drain for condensate. When measuring gas of a higher humidity, such as measuring gas having a temperature above a temperature of the sensor head, is transported to the sensor head through the transport tube, water or other substances contained in the measuring gas can condense. It is important that the condensate does not form at the sensor head since this would affect its function. If the condensate forms in the transport tube, however, the drain for the condensate can advantageously be formed on the transport tube and/or the pump. The drain can also be a collecting tank or the like for condensate.

The pump can be disposed upstream of the sensor head in the transport tube in a flow direction of the measuring gas. In this case, it is possible for condensate potentially forming in the transport tube to be separated from the measuring gas upstream of the sensor head. In this case, the pump cannot transport the condensate on toward the sensor head. Furthermore, it is also possible for the pump to be disposed downstream of the sensor head in a flow direction of the measuring gas. In this case, a mechanism for separating condensate can be provided upstream of the sensor head.

The gas sensor can have a fan for controlling the temperature of the transport tube with the measuring gas by forced convection. The fan can transport ambient air past the transport tube, for example, in which process the measuring gas located within the transport tube, which can be warmer or cooler than the ambient air, can approach or adapt to the temperature of the ambient air. Using the fan, the temperature of the measuring gas can be controlled by simple means so that the sensor head does not sustain damage, as a result of which the sensor head can reliably detect the gas potentially present in the measuring gas.

The gas sensor can be provided with a flow channel, at whose end the fan can be disposed; the transport tube can be at least partially disposed in the flow channel, and the fan can be configured to establish an air flow in the flow channel. For example, the flow channel can be formed by an elongate hollow body, such as a tube profile or a tube having open ends. The fan can be disposed in such manner at any end of the flow channel that the fan can transport ambient air through the flow channel.

In this case, this air or air flow can be directed at the transport tube in a targeted manner if the latter is at least partially, preferably for a large part of its entire length, disposed in the flow channel.

The fan can be an axial fan sein. Axial fans are particularly cost-efficient and can be mounted at an end of a flow channel in a simple manner, for example.

The transport tube can be at least partially coil-shaped, spiral or serpentine. This design of the transport tube allows a length of the transport tube to be significantly increased. This makes it possible for the temperature of the measuring gas transported through the transport tube to be controlled in a desired manner in a coil, a spiral or a serpent of the transport tube. The temperature can be controlled through another medium, such as air or water. In this case, the section of the transport tube in question forms a heat exchanger for the measuring gas.

The transport tube can be at least partially formed by a metal tube, preferably a copper tube or an aluminum tube. Advantageously, the transport tube is formed by a metal tube in the area in which the temperature of the measuring gas is controlled in the transport tube. The metal tube can provide a particularly good heat transfer between the measuring gas and the metal tube and an environment surrounding the metal tube. The materials copper and aluminum have an advantageous heat transfer coefficient. Furthermore, it is possible for the entire transport tube to be formed by a metal tube.

The transport tube can be formed by a plastic tube at least at an extraction point for the measuring gas on the test space. The extraction point can be formed by an opening in a wall of the test space, for example. A flange for connecting the transport tube to the test space can be provided on the opening. The plastic tube can be a plastic hose. The plastic tube can provide thermal insulation of the transport tube from the test space. If a wall of the test space is made of metal, such as stainless steel, the temperature of this wall is also controlled in accordance with a temperature in the test space. In this case, the transport tube, if made of metal, could be easily heated or cooled via the test space. This can be prevented by the fact that the transport tube is at least partially formed by a plastic tube at the extraction point. If the transport tube is also at least partially formed by a metal tube, it is advantageous for the plastic tube to extend from the extraction point to the metal tube or a portion of the transport tube that serves to control the temperature of the measuring gas.

Also, the transport tube can be formed by a plastic tube at least at a return point on the test space. As described above, this can provide an advantageous decoupling of the transport tube from a temperature of a wall of the test space. In this case, too, the plastic tube can be a plastic hose. In principle, it would also be possible for the measuring gas to be discharged to an environment downstream of the sensor head. However, this would have the result that the test space would no longer be fully sealed from an environment. To prevent this, the measuring gas can be returned into the atmosphere of the test space through the transport tube. In this case, the atmosphere of the test space is not changed by the gas sensor.

The test chamber according to the invention for conditioning air, in particular a temperature control chamber, a climate chamber or the like, comprises a temperature-insulated test space, which can be sealed from an environment and serves to hold test material, and a temperature control device for controlling the temperature of the test space, the temperature control device being configured to establish a temperature in a temperature range of −50° C. to +180° C. within the test space, the temperature control device having a heating feature and a cooling feature with a cooling circuit with a refrigerant, a heat exchanger in the test space, a compressor, a condenser and an expansion member, wherein the test chamber comprises at least one gas sensor according to the invention for detecting refrigerant in the test space. Regarding the advantages of the test chamber according to the invention, reference is made to the description of advantages of the gas sensor according to the invention. The test chamber according to the invention allows gases or refrigerant escaping into the test space to be reliably detected in time in the entire temperature range that can be established within the test space. In this manner, the gas sensor can prevent a potential explosion in the test space in the event of a leak of the cooling feature or the cooling circuit. Furthermore, the test chamber can also comply with the ATEX directives of the European Union, in particular ATEX equipment directive 2014/34/EU and/or ATEX workplace directive 1999/92/EG in their latest versions as at the priority date in this case.

The refrigerant can be flammable and/or can be a hydrocarbon or a refrigerant mixture of hydrocarbons, for example. Consequently, the refrigerant can be free from fluorinated hydrocarbons. The refrigerant can also consist of a single substance. For example, the refrigerant can be propane, ethane, ethylene, propene, isobutane, butane or the like. The refrigerant can also be a refrigerant mixture of hydrocarbons, i.e., the components mentioned above, or a refrigerant mixture with mainly hydrocarbons. This makes it possible to comply with future regulative requirements posed on refrigerants and to avoid the disadvantages of fluorinated hydrocarbons. Also, the refrigerant can be suitable for establishing a temperature in a temperature range of −40° C. to +180° C., preferably −70° C. to +180° C., particularly preferably up to −85° C. to +200° C., within the test space.

The test chamber can comprise a ventilation system having a detector with at least the gas sensor for detecting refrigerant in the test space; the detector can comprise at least one other gas sensor in a machine room of the test chamber, the machine room being separated from the test space in an air-tight manner. Since air is typically present in the test space, an explosive atmosphere can easily form, which can lead to an explosion in connection with a possibly operational electrical resistance heating element of the heating feature, for example. To prevent this, a ventilation system of the test chamber can be provided, which can suction air out of the test space. In this case, the ventilation system comprises the detector with the gas sensor for detecting refrigerant and/or detecting refrigerants used in the cooling circuit. The gas sensor can be disposed directly in the test space, on the test space, connected to the test space or attached to the test space in such a manner that escaped refrigerant in the test space can be detected quickly. Furthermore, an exhaust duct can be connected to the test space with the result that the fan can transport the air from the test space into the exhaust duct and thus out of test space. Make-up air from an environment can flow into the test space through an opening, such as a pressure compensation device or an air supply duct, provided in the test space for this very purpose. The fan itself can be composed of a fan motor and a fan impeller; the fan motor can be disposed in an air-tight enclosure. This enables the use of fan motors not conforming to ATEX. Overall, the ventilation system can be equipped for use under explosive conditions by simple means in this manner. Furthermore, the detector can comprise at least one other gas sensor in or on the machine room, which is separated from the test space in an air-tight manner. The other gas sensor can detect escaping refrigerant in the machine room in the case of a leak of the cooling circuit within the machine room. In this case, too, the ventilation system can be used to suction air out of the machine room only or alternatively out of the test space and the machine room at the same time. A valve box in which the valves of the cooling feature or the cooling circuit are integrated can be disposed in the machine room. The valve box can be open toward the machine room to ensure that refrigerant can leave the valve box if a leak is present in this location. This leak can also be detected by means of the other gas sensor. The other gas sensor in the machine room can preferably be disposed at a bottom of the machine room. In this manner, leaking refrigerant, i.e., hydrocarbon, which is heavier than air, can sink to the bottom and be reliably detected there. Potential ventilation openings in the machine room or a housing of the test chamber can be disposed above the bottom, for example, 10 cm above the bottom, of the machine room, so that leaking refrigerant cannot leave the machine room undetected.

Other advantageous embodiments of the test chamber are apparent from the description of features of the dependent claims referring to claim 1.

In the method according to the invention for detecting gas in a test space of a test chamber for conditioning air, in particular a temperature control chamber, a climate chamber or the like, a sensor head of a gas sensor is brought into contact with an atmosphere of the test space, wherein the gas sensor is used to detect a gas, in particular a refrigerant and/or a hydrocarbon, in the test space, a measuring gas being transported from the test space to the sensor head through a transport tube of the gas sensor. Regarding the advantageous effects of the method according to the invention, reference is made to the description of features of the gas sensor according to the invention. Other advantageous embodiments of the method are apparent from the description of features of the dependent claims referring to device claim 1.

Hereinafter, preferred embodiments of the invention will be discussed in more detail with reference to the accompanying drawings.

FIG. 1 is a schematic illustration of a test chamber in a section view;

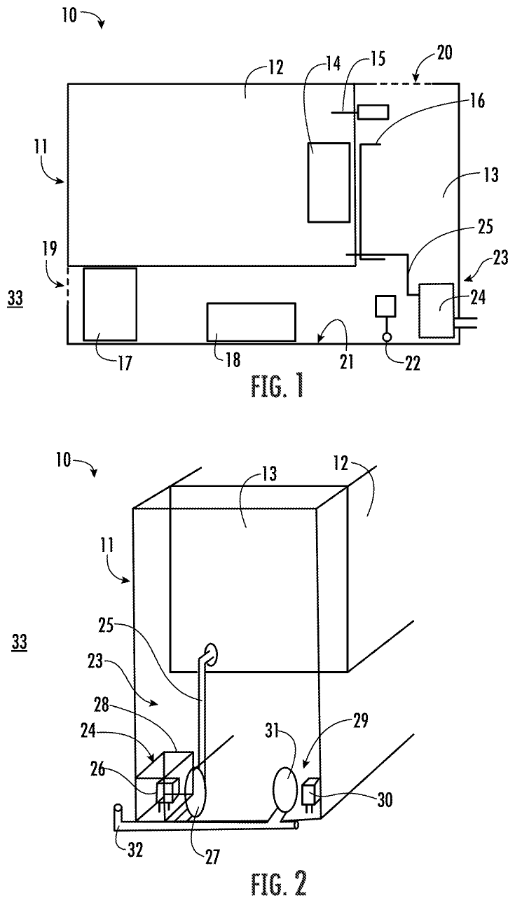

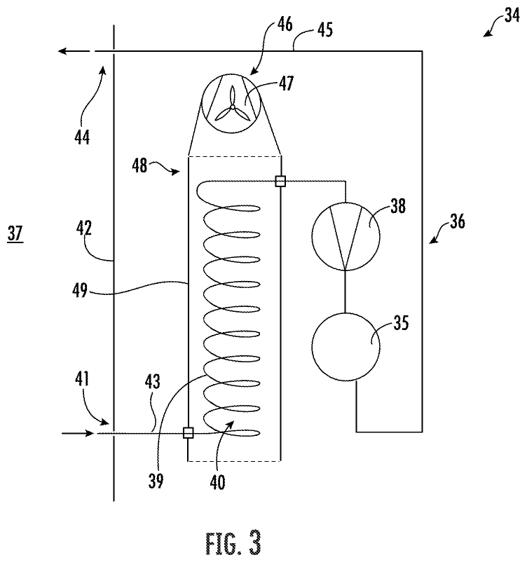

FIG. 2 is a schematic illustration of the test chamber in a perspective partial view;

FIG. 3 is a schematic diagram of a gas sensor.

FIGS. 1 and 2 show schematic illustrations of a test chamber 10 with a housing 11, within which a test space 12 and a machine room 13 are formed. A heat exchanger 14 of a cooling circuit (not shown) of a temperature control device of test chamber 10 is disposed in test space 12. A test space fan 15 can be used to circulate air within test space 12 past heat exchanger 14. A valve box 16, in which valves (not shown) of the cooling circuit are integrated, is disposed in machine room 13. Valve box 16 is open toward machine room 13. Furthermore, a condenser 17 and a compressor 18 of the cooling circuit are disposed in machine room 13. Openings 19 and 20 for ventilating machine room 13 are formed in machine room 13. Another gas sensor 22 of a detector (not shown) is disposed at a bottom 21 of machine room 13. Moreover, a ventilation system 23 is provided in machine room 13. Ventilation system 23 comprises a fan 24 and an exhaust duct 25, which is connected to test space 12. Fan 24 can transport air from test space 12 into exhaust duct 25 when refrigerant, in particular a hydrocarbon or a refrigerant mixture of hydrocarbons, is detected in test space 12 or in machine room 13 by a gas sensor (not shown) in or on test space 12 or by other gas sensor 22.

Fan 24 comprises a fan motor 26 and a fan impeller 27, fan motor 26 being disposed in an air-tight enclosure 28. Enclosure 28 is made of sheet metal and disposed within machine room 13. According to the illustration in FIG. 2, ventilation system 23 can comprise another fan 29, which is composed of a fan motor 30 and a fan impeller 33. Fan 29 allows ventilating machine room 13. Fan motor 26 can be a conventional fan motor, which does not have to be configured for operation in explosive atmospheres. Fan 29, on the other hand, is intended for use in explosive atmospheres. Fan 24 and fan 29 are connected to a common duct section 32 of exhaust duct 25. In the case at hand, common duct section 32 runs outside of housing 11 in an environment 33. As a result, a potential explosive mixture of refrigerant and air is located outside of housing 11.

FIG. 3 shows a schematic view of a gas sensor 34, which can be installed in the test chamber described in connection with FIGS. 1 and 2 as is. Gas sensor 34 comprises a sensor head 35, a transport tube 36 for transporting measuring gas of a test space 37, and a pump 38. Transport tube 36 is partially formed by a copper tube 39, which itself forms a coil 40. At an extraction point 41 for measuring gas in a wall 42 of test space 37, transport tube 36 is formed by a plastic tube 43, which extends from extraction point 41 to coil 40. Furthermore, transport tube 36 is connected to test space 37 at a return point 44 in wall 42 with the result that measuring gas can be transported back into test space 37 via return point 44. Transport tube 36 is also formed by a plastic tube 45 from return point 44 to sensor head 35. Thus, pump 38 can aspirate measuring gas from test space 37 and transport it to coil 44 via extraction point 41 and plastic tube 43 and from coil 44 to pump 38 and then to sensor head 35. After passing sensor head 35, the measuring gas is transported back into test space 37 via plastic tube 45.

Furthermore, gas sensor 34 comprises a fan 46, which is formed by an axial fan 47. Fan 46 is disposed at an end 48 of a flow channel 49 of gas sensor 34. Coil 40 is disposed within flow channel 49. When fan 46 is operated, an air flow is established in flow channel 49, said air flow controlling the temperature of transport tube 36 and the measuring gas located in coil 40 by forced convection. A temperature of the established air flow essentially corresponds to an ambient temperature of gas sensor 34 or a test chamber, which means that significantly colder or hotter measuring gas from the test space is heated or cooled, a temperature of the measuring gas thus being brought closer to a temperature of the environment. This makes it possible for gas sensor 34 to also detect gases in an atmosphere whose temperature would otherwise damage or affect sensor head 35.

1. A gas sensor comprising
a sensor head configured to be brought into contact with an atmosphere of the test space,
wherein the gas sensor is configured to detect a gas in a test space of a test chamber, the gas sensor having a transport tube configured to transport a measuring gas from the test space to the sensor head.

2. The gas sensor according to claim 1, wherein
the gas sensor is configured to detect the gas in the test space at a temperature in a temperature range from −50° C. to +180° C.

3. The gas sensor according to claim 1, wherein
the gas sensor is configured to detect a change in a composition of the atmosphere of the test space.

4. The gas sensor according to claim 1, wherein
the gas sensor is calibrated to detect a refrigerant.

5. The gas sensor according to claim 1, wherein the sensor head is configured as a reaction heat sensor or an infrared sensor.

6. The gas sensor according to claim 1, wherein
the gas sensor has a pump configured to transport the measuring gas from the test space to the sensor head through the transport tube.

7. The gas sensor according to claim 6, wherein
the pump and/or the transport tube is provided with a drain for condensate.

8. The gas sensor according to claim 6, wherein
the pump is disposed upstream from the sensor head in the transport tube in a flow direction of the measuring gas.

9. The gas sensor according to claim 1, wherein
the gas sensor has a fan the configured to control a temperature of the transport tube with the measuring gas by forced convection.

10. The gas sensor according to claim 9, wherein
the gas sensor is provided with a flow channel having an end and a fan disposed at the end,
wherein the transport tube is at least partially disposed in the flow channel, and the fan is configured to establish an air flow in the flow channel.

11. The gas sensor according to claim 9, wherein
the fan is an axial fan.

12. The gas sensor according to claim 1, wherein
the transport tube is at least partially coil-shaped, spiral, or serpentine.

13. The gas sensor according to claim 1, wherein
the transport tube is at least partially formed by a metal tube.

14. The gas sensor according to claim 1, wherein
the transport tube is formed by a plastic tube at least at an extraction point for measuring gas at the test space.

15. The gas sensor according to claim 1, wherein
the transport tube is formed by a plastic tube at least at a return point at the test space.

16. A test chamber comprising:
a temperature-insulated test space configured to be sealable from an environment to hold test material, and
a temperature control device configured to control a temperature of the test space, the temperature control device being configured to establish the temperature in a temperature range of −50° C. to +180° C. within the test space, the temperature control device having a heating feature and a cooling feature with a cooling circuit containing a refrigerant, a heat exchanger in the test space, a compressor, a condenser, and an expansion member, wherein
the test chamber comprises at least one gas sensor according to claim 1 that is configured to detect refrigerant in the test space.

17. The test chamber according to claim 16, wherein
the refrigerant is flammable and/or a hydrocarbon or a refrigerant mixture of hydrocarbons.

18. The test chamber according to claim 16, wherein
test chamber comprises a ventilation system having a detector with at least the gas sensor configured to detect a refrigerant in the test space, the detector comprising at least one other gas sensor in a machine room of the test chamber, the machine room being separated from the test space in an air-tight manner.

19. A method for detecting a gas in a test space of a test chamber for conditioning air, the method comprising:
transporting a measuring gas from the test space to a sensor head of the gas sensor through a transport tube of the gas sensor,
bringing a sensor head of a gas sensor in contact with an atmosphere of the test space, and
detecting the gas with the gas sensor.
